(19) United States
(12) Patent Application Publication
(10) Pub. No.: US 2005/0178747 A1
(43) Pub. Date: Aug. 18, 2005

(54) Flame photometric detector of gas chromatograph

(75) Inventor: Shigeaki Shibamoto, Kyoto-shi (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: SHIMADZU CORPORATION, Kyoto-shi (JP)

(21) Appl. No.: 11/088,951

(22) Filed: Mar. 25, 2005

(30) Foreign Application Priority Data
Jan. 13, 2004 (JP) 2004-006070

(51) Int. Cl. B23K 9/00

(52) U.S. Cl. 219/121.47

(57) ABSTRACT

A flame photometric detector for a gas-chromatograph is arranged such that a mixture of a column outflow gas and a fuel gas ejects from a tip of a nozzle, and the mixture and supporting gas are mixed and burn inside a combustion chamber. Light with a particular wavelength is generated from a flame and detected. The flame photometric detector includes a plurality of nozzle centers detachably fitted in the tip of the nozzle and having different inner diameters. One of the detachable nozzle centers suitable for analysis is fitted in the tip of the nozzle inside the FPD detector.

### BACKGROUND OF THE INVENTION AND RELATED ART STATEMENT

The present invention relates to a flame photometric detector used as a detector of a gas-chromatograph.

A flame photometric detector (FPD) is a detector used for a gas-chromatograph, and has high sensitivity relative to a compound of sulfur or phosphorus. FIG. 1 shows a cross sectional view of a structure of a conventional FPD (Patent Document 1). In FIG. 1, reference numerals 1 to 3 represent gas-chromatograph channels connected to the FPD. More specifically, carrier gas adjusted at a constant pressure or constant flow rate is introduced from a carrier gas introductory part, and flows into the detector (FPD cell 4) through a sample inlet 2 and a column 3. A sample from the sample inlet 2 is separated into each constituent while passing through the column 3 with the carrier gas. Hereinafter, the carrier gas flowing out of the tip of the column and constituent gas of a separated sample constituent are referred to as column outflow gas.

Hydrogen as fuel gas and air as supporting gas are introduced into the FPD cell 4 through conduits 51 and 61, respectively. The introduced fuel gas flows upwardly through a fuel gas passage 5 along a central axis of the cylindrical FPD cell. An upper end of the fuel gas passage 5 forms a nozzle 7 opening toward a fuel chamber 42. A tip of the column is inserted into the fuel gas passage 5 from a lower side of the FPD cell 4, and fixed by a nut 31 and a ferrule 32. The supporting gas passes through a supporting gas passage 62 surrounding the fuel gas passage 5, and is ejected from a supporting gas outlet 6 disposed around the nozzle. The supporting gas outlet 6 is formed of a number of eyeholes opening near the nozzle toward the fuel chamber 42. Alternatively, the supporting gas outlet 6 can be constituted as a gap above a slit surrounding the nozzle. Hydrogen and air are used as the fuel gas and the supporting gas, and different types of gases other than the gases previously mentioned can be used.

The fuel chamber 42 is a space above the nozzle 7 covered with a cell external cylinder 41. The fuel gas reacts with oxygen in the supporting gas, and burns to form a flame 8. Exhaust gas after burning is discharged out of a vent 43 at an upper part of the cell external cylinder.

The column outflow gas is mixed with the fuel gas inside the fuel gas passage 5, and is blown into the flame 8 from the nozzle 7. When the sample contains a constituent including sulfur and phosphorus, light with a particular wavelength is generated in the flame 8. An intensity of light is measured by a photometry 10 provided at a side of the flame 8. More specifically, light emanated from the flame 8 transmits through a quartz window 13, and enters the photometry 10. Then, light emanated from the flame 8 passes through an interference filter 11, so that light with a particular wavelength passes through as a measuring object. Light emanated from the flame 8 is changed into an electronic signal at a photo multiplier 12, and emitted to an outside measuring circuit (not shown).

The frame 8 is formed at the nozzle 7 of the FPD. When the nozzle 7 does not have an optimal inner diameter suitable for a flow rate of the gas, the flame does not burn well, thereby making it difficult to ignite or losing flame. Generally, a flow rate of the gas through a nozzle portion differs widely according to an analytical condition. For example, a flow volume of the carrier gas differs widely between a case wherein a capillary column is used and a case wherein a packed column is used, so that a nozzle with a different inner diameter needs to be used according to the flow rate of the carrier gas.

Patent Document 1: Japanese Patent Publication (Kokai) No. 2002-22661

An optimal inner diameter of the FPD nozzle differs widely by the analytical condition, especially, the flow rate. For example, when the capillary column is used, the gas volume differs from that of the packed column. Accordingly, a nozzle with an optimal inner diameter needs to be used so as to properly burn the flame. A conventional nozzle is designed to be fitted in one of the capillary column or the packed column. Accordingly, when the packed column is used and the flow volume of the carrier gas is large, a FPD nozzle with a small inner diameter for the capillary column does not easily ignite the flame, or not ignite the flame at all. Moreover, even if the flame is ignited, the flame burns out during solvent elution. On the other hand, when the capillary column is used, a nozzle with a large inner diameter for the packed column deteriorates sensitivity. As a result, conventionally, in order to properly burn the flame according to the analytical condition, a nozzle with a different inner diameter had to be provided according to the column.

In view of the above-mentioned problems, an object of the present invention is to provide an FPD detector of a gas-chromatograph wherein a flame can be burnt with an optimal inner diameter for an analytical condition without changing a nozzle main body.

Further objects and advantages of the invention will be apparent from the following description of the invention.

### SUMMARY OF INVENTION

In order to achieve the objects mentioned above, according to the present invention; a flame photometric detector of a gas-chromatograph is arranged such that a mixed gas of a column outflow gas and a fuel gas ejects from a tip of a nozzle, and the mixed gas and supporting gas are mixed and burn inside a combustion chamber. Light with a particular wavelength is generated from a flame and detected. The flame photometric detector for the gas-chromatograph includes a plurality of nozzle centers capable of being fitted in the tip of the nozzle and having different inner diameters. The detachable nozzle center with a different inner diameter can be fitted in the tip of the nozzle inside the FPD detector of the gas-chromatograph for ejecting the mixed gas of the column outflow gas and the fuel gas.

With the above-described structure, when a packed column and a capillary column are used, an optimal nozzle center is selected to easily change the inner diameter of the nozzle without changing a nozzle main body.

Conventionally, when an analytical condition is changed, an FPD detector also needs to be changed to use a nozzle with a different inner diameter, thereby making the process complicated. It is also necessary to provide a number of nozzles for each condition of the capillary column and the packed column. In the present invention, when an analytical condition is changed, only the nozzle center of the FPD detector is changed, so that the flame is burnt with the nozzle having an optimal inner diameter. An optical analysis can be carried out with a common nozzle without replacing a nozzle main body. Also, the inner diameter of the nozzle might be changed when a flow rate of the carrier gas or an injection volume of a sample is changed, in addition to a case that the inner diameter of the column is changed.

### BRIEF DESCRIPTION OF THE DRAWINGS

FIG. 1 is a drawing showing a constitutional example of a conventional FPD;

FIGS. 2(a) and 2(b) are views showing a nozzle portion of an FPD; and

FIGS. 3(a) to 3(c) are views showing a tip of the nozzle portion and nozzle centers according to an embodiment of the present invention.

### DETAILED DESCRIPTION OF PREFERRED EMBODIMENTS

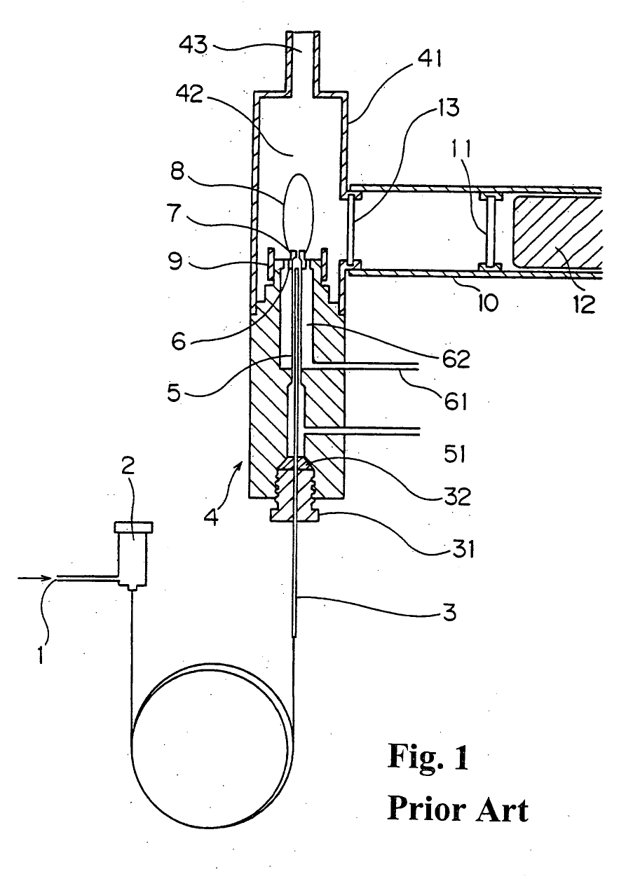

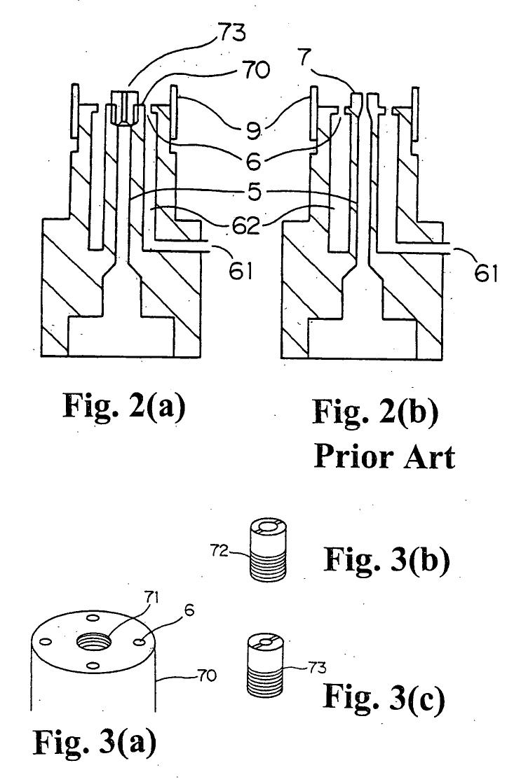

Hereunder, embodiments of the present invention will be explained with reference to the accompanying drawings. FIG. 2(a) shows an FPD nozzle according to an embodiment of the present invention. FIG. 2(b) shows a conventional FPD nozzle. FIGS. 2(a) and 2(b) show only the nozzles inside FPD detectors, and parts not shown in the drawing are the same as that in FIG. 1. In FIGS. 2(a) and 2(b), column outflow gas is mixed with fuel gas inside a fuel gas passage 5. The column outflow gas and the fuel gas are ejected from the nozzle and burn to form a flame. Supporting gas passes through a supporting gas passage 62, and is ejected from a supporting gas outlet 6, thereby supplying the supporting gas necessary for combustion.

The nozzle of the present invention has a tip different from that of the conventional nozzle. A tip 7 of the conventional nozzle is formed in such a way that an upper end of a fuel gas passage is narrowed, and an inner diameter of the tip 7 is constant. As shown in FIG. 3(a), a screw portion 71 is formed on an inner circumference of the tip 70 of the nozzle according to the present invention. As shown in FIGS. 3(b) and 3(c), nozzle centers 72 and 73 have different inner diameters. The nozzle centers 72 and 73 include a screw portion on outer circumferences thereof, respectively, so that they can be fitted into the screw portion 71 of the tip of the nozzle.

When a packed column is used, a nozzle center with the inner diameter 1.5±0.1-mm is used (FIG. 3(b)). When a capillary column is used, the nozzle center with the inner diameter 0.8±0.1 mm is used (FIG. 3(c)). These values are some examples of an optimal inner diameter. The optimal inner diameter is not limited to these values, and may be changed according to an analytical condition. Accordingly, the inner diameter of the nozzle can be changed without changing a nozzle main body. A method of attaching and removing the screw portion 71 is not limited to a screw type. For example, a fit-in type can be used.

The disclosure of Japanese Patent Application No. 2004-006070, filed on Jan. 13, 2004, is incorporated in the application.

While the invention has been explained with reference to the specific embodiments of the invention, the explanation is illustrative and the invention is limited only by the appended claims.

1. A flame photometric detector for a gas-chromatograph, comprising:
a nozzle having a tip portion for ejecting column outflow gas, and
a nozzle center device detachably attached to the tip portion.

2. A flame photometric detector according to claim 1, wherein said nozzle center device includes a plurality of nozzle centers with different diameters, one of said plurality of nozzle centers suitable for analysis being attached to the tip portion of the nozzle.

3. A flame photometric detector according to claim 2, wherein said nozzle includes a fuel gas passage and a supporting gas passage, said tip portion communicating with the fuel gas passage to eject a mixture of the column outflow gas and the fuel gas.

4. A flame photometric detector according to claim 2, wherein said tip portion of the nozzle has a female screw portion formed in an inner surface thereof, and said nozzle center has a male screw portion formed on an outer surface thereof so that the nozzle center can be screwed into the tip portion.
